(19) United States
(12) Patent Application Publication
(10) Pub. No.: US 2025/0364697 A1
(43) Pub. Date: Nov. 27, 2025

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuya IKEDA, Osaka (JP); Osamu NAKAYAMA, Osaka (JP); Nobuyuki MATSUMURA, Osaka (JP); Yoshinori IKAI, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/854,819

(22) PCT Filed: Apr. 12, 2023
(86) PCT No.: PCT/JP2023/014879

§ 371 Date: Jul. 9, 2025

(30) Foreign Application Priority Data
Apr. 26, 2022 (JP) 2022-072267

(51) Int. Cl. H01M 50/507; H01M 50/249; H01M 50/514; H01M 50/519; H01M 50/583

(52) U.S. Cl. CPC H01M 50/507; H01M 50/249; H01M 50/514; H01M 50/519; H01M 50/583

(57) ABSTRACT

A wiring module to be attached to a plurality of power storage devices includes a busbar to be connected to electrode terminals of the plurality of power storage devices, a circuit board, a first wire electrically connecting the busbar to the circuit board, and a second wire, with the circuit board having formed thereon a conduction path having a first land electrically connected to the first wire, a second land electrically connected to the second wire, and a fuse part provided between the first land and the second land.

### TECHNICAL FIELD

The present disclosure relates to a wiring module.

### BACKGROUND ART

High-voltage battery packs used in electric vehicles, hybrid vehicles, and the like typically have a large number of stacked battery cells that are electrically connected in series or parallel by a wiring module. Conventionally, a known example of such a wiring module is a busbar assembly described in JP 2019-500736T (Patent Document 1 below). The busbar assembly described in Patent Document 1 is attached to a plurality of battery cells that have electrode leads protruding on at least one side thereof and are stacked one on the other, and is constituted to include a busbar frame provided with lead slots through which the electrode leads are passed, and busbars electrically coupling the electrode leads that pass through the lead slots.

### CITATION LIST

### Patent Documents

Patent Document 1: JP 2019-500736T

### SUMMARY OF INVENTION

### Technical Problem

In the above configuration, the busbar assembly does not have a fuse function. Adding a fuse function to the wiring module is conceivably achieved by incorporating a circuit board that includes a fuse into the wiring module. However, use of a circuit board is liable to increase the manufacturing costs of the wiring module.

Also, the battery cells expand or contract due to temperature changes associated with vehicle use. The circuit board may thereby be damaged primarily at the connecting portions between the busbars and the circuit board, and the electrical connection between the busbars and the circuit board may be impaired.

### Solution to Problem

A wiring module of the present disclosure is a wiring module to be attached to a plurality of power storage devices, including a busbar to be connected to electrode terminals of the plurality of power storage devices, a circuit board, a first wire electrically connecting the busbar to the circuit board, and a second wire, with the circuit board having formed thereon a conduction path having a first land electrically connected to the first wire, a second land electrically connected to the second wire, and a fuse part provided between the first land and the second land.

### Advantageous Effects of Invention

According to the present disclosure, a wiring module that is able to suppress an increase in manufacturing costs related to addition of a fuse function and to maintain an electrical connection between a circuit board and a busbar can be provided.

### BRIEF DESCRIPTION OF DRAWINGS

FIG. 1 is a schematic view showing a vehicle equipped with a power storage module according to a first embodiment.

FIG. 2 is a plan view of the power storage module.

FIG. 3 is a partially enlarged plan view of the power storage module showing the periphery of a circuit board.

FIG. 4 is a perspective view of the power storage module showing the periphery of the circuit board.

FIG. 5 is a plan view of the circuit board.

FIG. 6 is a schematic sectional view taken along line A-A in FIG. 5.

FIG. 7 is a perspective view of a terminal.

FIG. 8 is a partially enlarged plan view of a power storage module showing the periphery of a circuit board according to a second embodiment.

FIG. 9 is a partially enlarged plan view of a power storage module showing the periphery of a circuit board according to a third embodiment.

### DESCRIPTION OF EMBODIMENTS OF DISCLOSURE

Initially modes of the present disclosure will be enumerated and described.

(1) A wiring module of the present disclosure is a wiring module to be attached to a plurality of power storage devices, including a busbar to be connected to electrode terminals of the plurality of power storage devices, a circuit board, a first wire electrically connecting the busbar to the circuit board, and a second wire, with the circuit board having formed thereon a conduction path having a first land electrically connected to the first wire, a second land electrically connected to the second wire, and a fuse part provided between the first land and the second land.

According to such a configuration, the wiring module is provided with the first wire and the second wire in addition to the circuit board, thus enabling the amount of use of the circuit board to be reduced, compared to when the first wire and the second wire are not provided. Therefore, the manufacturing costs of the wiring module can be reduced.

(2) Preferably, the first wire has a shape curving between an end portion thereof on the busbar side and an end portion thereof on the circuit board side.

According to such a configuration, the first wire electrically connecting the circuit board and the busbar is curved, thus allowing for displacement of the busbar relative to the circuit board. Therefore, even if the power storage devices expand or contract following a temperature change, or the busbar deforms due to an external force being applied to the wiring module, the circuit board is unlikely to be damaged, and the electrical connection between the busbar and the circuit board can be maintained.

(3) Preferably, the wiring module further includes a terminal, and the terminal includes a crimping part crimped onto the end portion of the first wire on the circuit board side and a connecting part connected to the first land.

According to such a configuration, electrically connecting the first wire and the first land may be easier using the terminal.

(4) Preferably, the terminal includes a press-fit part different from the connecting part, and the circuit board has a press-fit hole into which the press-fit part is press-fit.

According to such a configuration, the terminal can be fixed with respect to the circuit board, by the press-fit part being press-fit into the press-fit hole.

(5) Preferably, at least one of the circuit board has a plurality of the conduction path formed thereon.

According to such a configuration, the number of the circuit boards used in the wiring module can be reduced, thus enabling the ease of assembly of the wiring module to be improved.

(6) Preferably, the circuit board is a rigid board.

According to such a configuration, it is easy to improve the strength of the circuit board. Also, the manufacturing costs of the wiring module can be suppressed, compared to the case where a flexible board is used as the circuit board.

(7) Preferably, the fuse part is constituted by a chip fuse connected to the conduction path by solder.

According to such a configuration, the conduction path can be protected from overcurrent, by the chip fuse melting when overcurrent flows through the conduction path.

(8) Preferably, the circuit board is a flexible board.

According to such a configuration, the circuit board can be provided with flexibility.

(9) Preferably, the fuse part is constituted by a pattern fuse.

According to such a configuration, the fuse part can be constituted in a manufacturing process of the flexible board.

(10) Preferably, the flexible board has a reinforcing plate adhered thereto.

According to such a configuration, the strength of the flexible board can be improved.

(11) The above wiring module is a vehicle wiring module to be electrically attached to the plurality of power storage devices installed in a vehicle.

### DETAILED DESCRIPTION OF EMBODIMENTS OF DISCLOSURE

Hereinafter, embodiments of the present disclosure will be described. The present disclosure is not limited to these illustrative examples and is defined by the claims, and all changes that come within the meaning and range of equivalency of the claims are intended to be embraced therein.

### First Embodiment

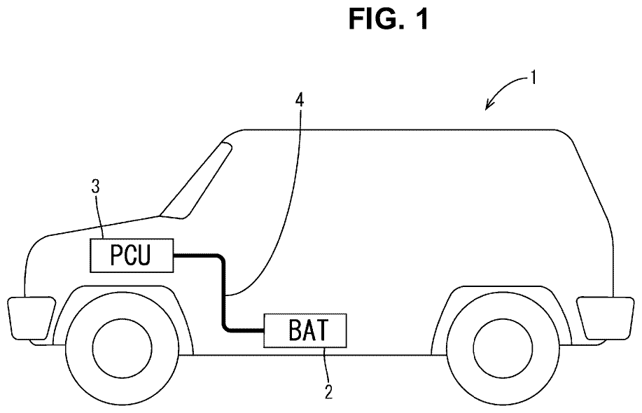

A first embodiment of the present disclosure will now be described with reference to FIGS. 1 to 7. A power storage module 10 provided with a wiring module 20 of the present embodiment is, for example, applied to a power storage pack 2 installed in a vehicle 1, as shown in FIG. 1. The power storage pack 2 is installed in the vehicle 1, which is an electric vehicle, a hybrid vehicle, or the like, and used as a drive source of the vehicle 1. In the following description, only some of a plurality of identical members may be denoted by reference numerals, and the reference numerals of the remaining members may be omitted.

As shown in FIG. 1, the power storage pack 2 is arranged near the center of the vehicle 1. A PCU 3 (Power Control Unit) is arranged in a front portion of the vehicle 1. The power storage pack 2 and the PCU 3 are connected by a wire harness 4. The power storage pack 2 and the wire harness 4 are connected by a connector not shown. The power storage pack 2 has the power storage module 10 provided with a plurality of power storage devices 11. The power storage module 10 (and the wiring module 20) can be installed in any orientation, and, hereinafter, except for FIG. 1, the direction indicated by an arrow Z is upward, the direction indicated by an arrow X is forward, and the direction indicated by an arrow Y is leftward.

### Power Storage Devices, Electrode Terminals

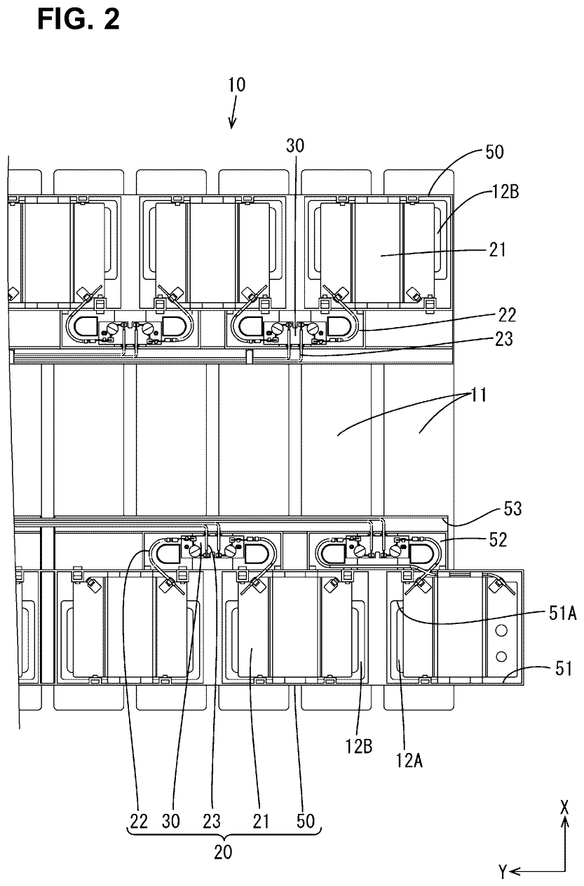

As shown in FIG. 2, the power storage module 10 includes the plurality of power storage devices 11 arranged in a row in a left-right direction, and the wiring module 20 mounted on upper surfaces of the plurality of power storage devices 11 (left side portion of the power storage module 10 is not shown). The power storage devices 11 have a flattened rectangular parallelepiped shape. Inside the power storage devices 11 are housed power storage elements not shown. The power storage devices 11 have positive and negative electrode terminals 12A and 12B on the upper surface thereof. The power storage devices 11 are not particularly limited, and may be secondary batteries or may be capacitors. The power storage devices 11 according to the present embodiment are secondary batteries.

### Wiring Module

The wiring module 20 includes busbars 21 connected to the electrode terminals 12A and 12B, a circuit board 30, first wires 22 electrically connecting the busbars 21 to the circuit board 30, second wires 23 connected to the circuit board 30, and a protector 50 holding the busbars 21, the circuit board 30, and the second wires 23. The wiring module 20 is configured to be attached to the front side and rear side of the plurality of power storage devices 11. Hereinafter, the configuration of the wiring module 20 arranged on the rear side will be described in detail. Note that the wiring module 20 arranged on the front side is inverted in both the front-back direction and the left-right direction, but otherwise there is no difference between the configuration of the wiring module 20 arranged on the front side and the configuration of the wiring module 20 arranged on the rear side.

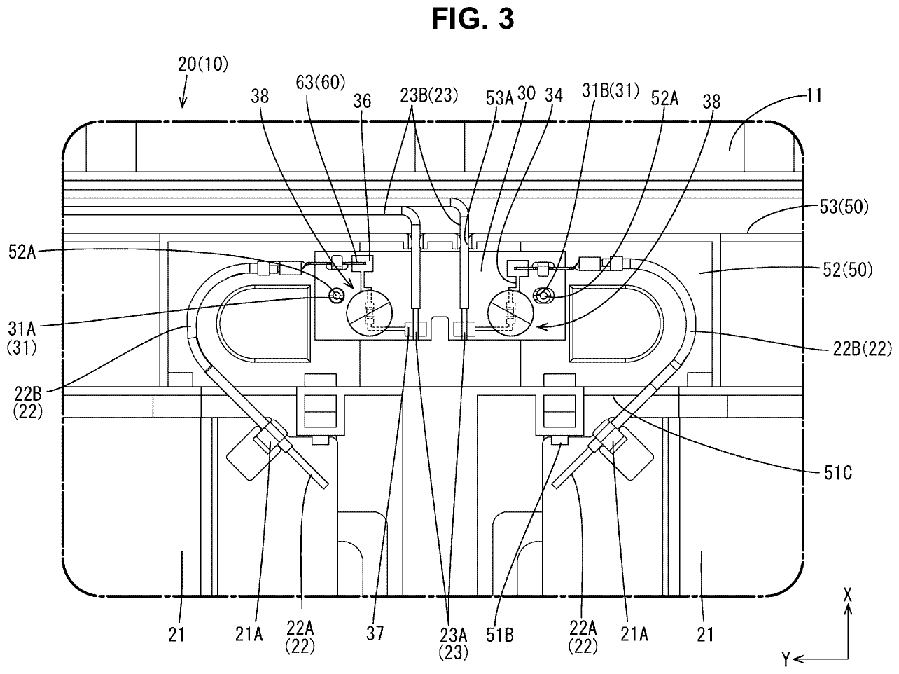

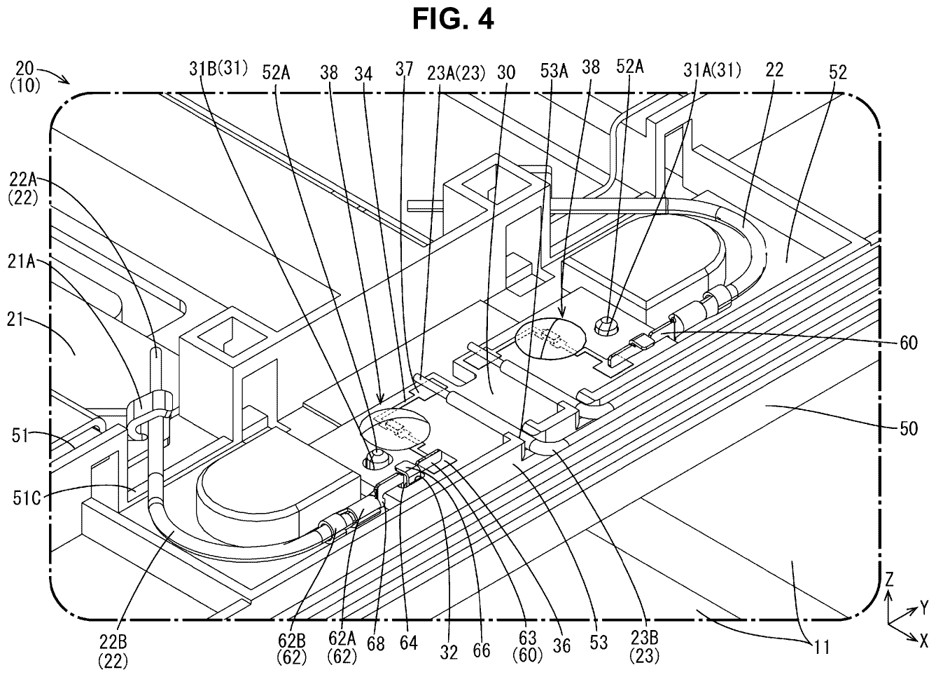

The protector 50 is made of an insulating synthetic resin and has a plate shape. The protector 50 includes a busbar housing part 51 in which the busbars 21 are housed, a board holding part 52 in which the circuit board 30 is held, and a wire routing part 53 on which the second wires 23 are routed. The busbar housing part 51 has a frame shape. Connection holes 51A for connecting the electrode terminals 12A and 12B to the busbars 21 are formed in a lower portion of the busbar housing part 51. As shown in FIG. 3, locking parts 51B for holding the busbars 21 within the busbar housing part 51 are provided on a peripheral wall of the busbar housing part 51. As shown in FIG. 4, a side wall of the busbar housing part 51 is provided with recessed parts 51C that are recessed downward in places. The first wires 22 are disposed within the recessed parts 51C.

As shown in FIG. 4, the wire routing part 53 has a groove shape extending in the left-right direction. The board holding part 52 is arranged between the busbar housing part 51 and the wire routing part 53. Wire insertion parts 53A are formed in a recessed shape in a groove wall on the board holding part 52 side of the wire routing part 53. The second wires 23 inserted into the wire insertion parts 53A are connected to the circuit board 30. The board holding part 52 includes protruding parts 52A that are inserted into insertion holes 31 in the circuit board 30. The protruding parts 52A have a cylindrical shape extending in the up-down direction.

### Busbars

The busbars 21 are made of a metal plate material having conductivity. Examples of the metal constituting the busbars 21 include copper, a copper alloy, aluminum, an aluminum alloy, and stainless steel (SUS). As shown in FIG. 2, the busbars 21 are rectangular in plan view. The busbars 21 and the electrode terminals 12A and 12B are electrically connected by welding. There are busbars 21 that connect the electrode terminals 12A and 12B of adjacent power storage devices 11, and busbars 21 that are connected to all the positive electrodes or all the negative electrodes of the plurality of power storage devices 11, but no particular distinction therebetween will be made below. As shown in FIG. 4, the busbars 21 each include a fastening part 21A that fastens the first wire 22. The fastening part 21A is formed by cutting and raising a vicinity of the side edge of the busbar 21. The busbar 21 and the first wire 22 are electrically connected by welding.

### First Wires

The first wires 22 each have a core wire 22A and an insulation coating 22B covering the core wire 22A. One end portion of the first wire 22 is connected to the busbar 21 by welding. In the present embodiment, the core wire 22A of the first wire 22 is made of the same type of metal as the busbar 21. The strength of the welded portion between the core wire 22A of the first wire 22 and the busbar 21 can thereby be improved.

The other end portion of the first wire 22 is electrically connected to a terminal 60 by being crimped by a crimping part 62 of the terminal 60. The terminal 60 is connected to the circuit board 30 by soldering. The first wire 22 has a shape that curves from the end portion thereof on the busbar 21 side to the end portion thereof on the circuit board 30 (terminal 60) side.

The first wires 22 electrically connecting the busbars 21 to the circuit board 30 are in a curved state. That is, the first wires 22 have residual length with respect to the linear distance between the busbars 21 and the circuit board 30. As a result of the first wires 22 deforming, the busbars 21 can be displaced to some extent in any of the direction in which the busbars 21 are arranged (left-right direction), the direction away from or closer to the circuit board 30 (front-back direction), and the thickness direction of the circuit board 30 (up-down direction). Thus, even if the temperature changes due to use of the vehicle 1 in which the power storage module 10 is installed and the power storage devices 11 (and busbars 21) expand or contract, or the busbars 21 deform due to an external force being applied to the wiring module 20, the connecting portions between the first wires 22 and the busbars 21 and the connecting portions between the first wires 22 and the circuit board 30 are unlikely to be damaged, making it easy to maintain the electrical connection between the busbars 21 and the circuit board 30 via the first wires 22.

### Terminals

The terminals 60 are formed by processing a metal plate having conductivity. Examples of the metal constituting the terminals 60 include copper, a copper alloy, aluminum, and an aluminum alloy. The terminals 60 of the present embodiment are made of a copper alloy. As shown in FIG. 4, the terminals 60 are each connected to a first land 36 of the circuit board 30 by soldering. For example, if the metal constituting the core wire 22A of the first wires 22 has poor wettability of molten solder, it is difficult to directly connect the first wires 22 to the circuit board 30 by soldering. In the present embodiment, the terminals 60 are provided between the first wires 22 and the circuit board 30, thus enabling the first wires 22 to be electrically connected to the circuit board 30, even if it is difficult to directly solder the first wires 22 to the circuit board 30.

A plating layer may be formed on the surface of the terminals 60. Examples of the metal constituting the plating layer include tin and nickel. The terminals 60 of the present embodiment have a plating layer made of tin. By forming such a plating layer, the molten solder wettability of the terminals 60 can be improved. Therefore, the terminals 60 and the first lands 36 of the circuit board 30 can be firmly connected by soldering.

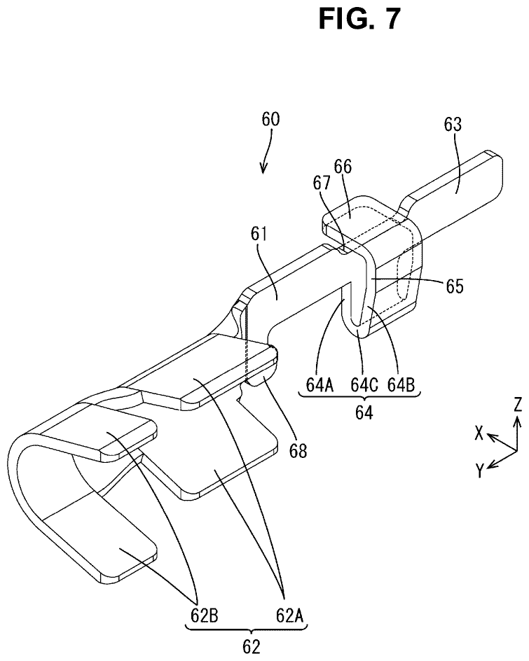

As shown in FIG. 7, the terminals 60 each include a terminal body 61, the crimping part 62 joined to the terminal body 61, a connecting part 63 arranged at the end portion of the terminal body 61 on the opposite side to the crimping part 62, and a press-fit part 64 extending downward from the terminal body 61. Note that, in FIG. 7, the front-back direction, the left-right direction, and the up-down direction are defined based on the posture of the terminal 60 arranged on the left side of FIG. 3. The terminal body 61 is long in the left-right direction and flattened in the front-back direction. As shown in FIG. 4, the crimping part 62 includes a wire barrel 62A that is crimped to the core wire 22A of the first wire 22 and an insulation barrel 62B that is crimped to the insulation coating 22B of the first wire 22. The connecting part 63 is configured to be connected to the first land 36 of the circuit board 30 by soldering.

As shown in FIG. 7, the press-fit part 64 is arranged between the connecting part 63 and the crimping part 62. The press-fit part 64 extends downward from the terminal body 61 and then bends upward. The press-fit part 64 includes a base part 64A extending downward from the terminal body 61, an opposing plate part 64B opposing the base part 64A in the front-back direction, and a bent part 64C connecting the base part 64A and the opposing plate part 64B. The press-fit part 64 has a leaf spring shape. The opposing plate part 64B inclines so as to be located further away from the base part 64A in the front-back direction proceeding upward. As shown in FIG. 4, the press-fit part 64 is configured to be press-fit into a press-fit hole 32 in the circuit board 30.

As shown in FIG. 7, the terminal 60 includes an extending part 65 extending upward from an upper end portion of the opposing plate part 64B of the press-fit part 64 and a pressing part 66 extending forward from an upper end portion of the extending part 65. The terminal 60 includes a press-receiving part 67 that is recessed downward from the upper surface of the terminal body 61. The pressing part 66 is configured to be arranged inside the press-receiving part 67. The press-fit part 64 is easily press-fit into the press-fit hole 32, by pressing the pressing part 66 (see FIG. 4).

As shown in FIG. 7, the terminal 60 includes a positioning raised part 68 on the crimping part 62 side of the terminal body 61. The positioning raised part 68 extends downward from the terminal body 61 and further extends so as to approach the press-fit part 64. The positioning raised part 68 opposes the press-fit part 64 in the left-right direction. After press-fitting the press-fit part 64 into the press-fit hole 32, the terminal 60 can be positioned with respect to the circuit board 30, by bringing the positioning raised part 68 into contact with the end face of the circuit board 30 (see FIG. 4). More specifically, positioning of the connecting part 63 and the first land 36 can be performed.

### Second Wires

As shown in FIG. 4, the second wires 23 each have a core wire 23A and an insulation coating 23B covering the core wire 23A. The core wire 23A exposed at one end of the second wire 23 is connected to a second land 37 by soldering. The insulation coating 23B at the one end of the second wire 23 is inserted into the wire insertion part 53A and fixed. Although not shown, the other end of the second wire 23 is connected to an external ECU (Electronic Control Unit) or the like via a connector. The ECU is equipped with a microcomputer, devices, and the like, and has a well-known configuration provided with functions such as detecting the voltage, current, temperature, and the like of each power storage device 11 and controlling charging and discharging of each power storage device 11.

### Circuit Board

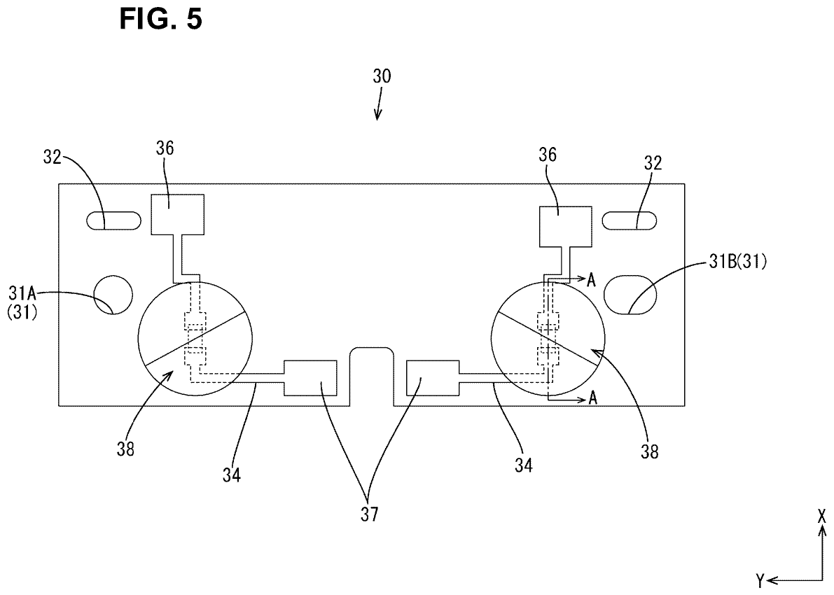

The circuit board 30 of the present embodiment is a rigid board that does not have flexibility. As shown in FIG. 5, the circuit board 30 has a long rectangular shape in the left-right direction in plan view. The circuit board 30 has insertion holes 31 and press-fit holes 32 that pass through the circuit board 30 in the up-down direction formed therein. The insertion holes 31 are provided one in the left end portion and one in the right end portion of the circuit board 30. One of the insertion holes 31 is a first insertion hole 31A having a substantially circular shape in plan view. The other insertion hole 31 is a second insertion hole 31B having a long hole shape extending in the left-right direction in plan view. The press-fit holes 32 are provided one in the left end portion and one in the right end portion of the circuit board 30. The press-fit holes 32 are arranged at positions adjacent to the first lands 36 in the left-right direction. The press-fit holes 32 have a long hole shape that is long in the left right direction in plan view.

As shown in FIG. 3, as a result of the protruding parts 52A of the protector 50 being inserted into the insertion holes 31, left-right and front-back movement of the circuit board 30 relative to the protector 50 is restricted. The second insertion hole 31B is a long hole, and thus has an internal shape that is large in the left-right direction with respect to the protruding part 52A which is cylindrical. Manufacturing tolerance of the insertion holes 31 and the protruding parts 52A in the left-right direction can thereby be absorbed.

As shown in FIG. 4, the press-fit parts 64 of the terminals 60 are press-fit into the press-fit holes 32. The hole diameter of each press-fit hole 32 in the left-right direction is set larger than the dimension of the press-fit part 64 in the left-right direction. The hole diameter of the press-fit hole 32 in the front-back direction is set slightly smaller than the dimension of the press-fit part 64 in the front-back direction in a natural state. Therefore, the press-fit part 64 arranged inside the press-fit hole 32 will be in an elastically deformed state in contact with an inner wall of the press-fit hole 32. The press-fit part 64 can thereby be retained within the press-fit hole 32, and the terminal 60 can be fixed with respect to the circuit board 30. By fixing the terminal 60 to the circuit board 30, soldering of the connecting part 63 of the terminal 60 to the circuit board 30 becomes easier to perform.

Also, the press-fit part 64 is arranged between the crimping part 62 and the connecting part 63, and thus, even if stress is applied to the first wire 22, this stress is born by the press-fit part 64 and the inner wall of the press-fit hole 32, thus enabling application of stress to the connecting portion between the connecting part 63 and the circuit board 30 to be suppressed.

### Conduction Path

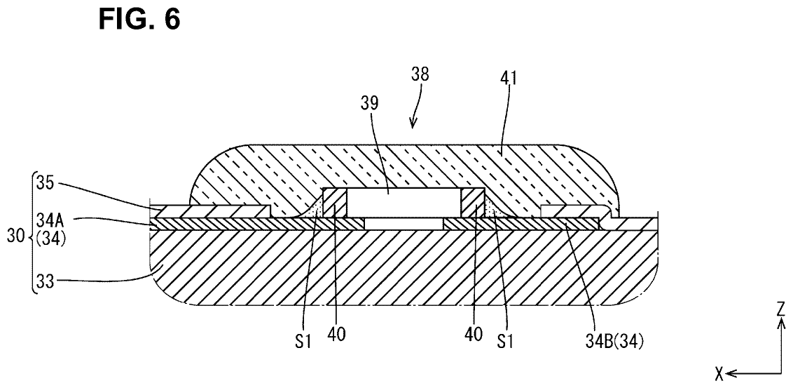

As shown in FIG. 6, the circuit board 30 includes an insulation plate 33 having insulating properties and a conduction path 34 routed on this insulation plate 33. The insulation plate 33 is formed by, for example, an epoxy resin being impregnated into a fiberglass cloth and cured. The conduction path 34 is made of a metal such as copper or a copper alloy, for example, and has conductivity. The conduction path 34 is covered with an insulation layer 35, except for the portions soldered to other members. The insulation layer 35 is constituted by a solder resist or the like. As shown in FIG. 5, the conduction path 34 includes the first land 36 arranged at one end of the conduction path 34, the second land 37 arranged at the other end of the conduction path 34, and a fuse part 38 provided between the first land 36 and the second land 37.

### First Lands, Second Lands

The first lands 36 are arranged one on the right side and one on the left side of the circuit board 30. Two second lands 37 are arranged toward the left-right center of the circuit board 30. As shown in FIG. 3, the first land 36 is soldered to the connecting part 63 of the terminal 60. The first land 36 is electrically connected to the busbar 21 via the terminal 60 and the first wire 22. The second land 37 is connected to the core wire 23A of the second wire 23 by soldering.

### Fuse Part

As shown in FIG. 5, the fuse part 38 is provided on a portion of the conduction path 34 partway between the first land 36 and the second land 37. As shown in FIG. 6, the fuse part 38 of the present embodiment has a chip fuse 39, and the chip fuse 39 is connected to the conduction path 34 by solder S1. Specifically, one of a pair of electrodes 40 of the chip fuse 39 is connected to a conduction path 34A on the first land 36 side, and the other of the pair is connected to a conduction path 34B on the second land 37 side.

As a result of the fuse parts 38 being provided, even when the conduction paths 34 are short-circuited and overcurrent occurs due to a fault in an external circuit to which the power storage module 10 is connected, flow of the overcurrent through the conduction paths 34 from the power storage devices 11 can be restricted, by the chip fuses 39 melting.

As shown in FIG. 6, in the present embodiment, a connecting portion between the chip fuse 39 and the conduction path 34 is covered by a sealing part 41. Here, the connecting portion between the chip fuse 39 and the conduction path 34 includes at least the entirety of the chip fuse 39, the solder S1, and end portions of the conduction path 34 connected to the electrodes 40 of the chip fuse 39, which are portions not covered by the insulation layer 35. The sealing part 41 is made of a curable insulating resin. Since the sealing part 41 covers the connecting portion between the chip fuse 39 and the conduction path 34, short-circuiting of the conduction path 34 can be suppressed, even when water droplets or the like form on the circuit board 30 due to condensation.

In the present embodiment, as shown in FIG. 3, the circuit board 30 is formed with the minimum dimensions necessary in order to form the first lands 36, the fuse parts 38, and the second lands 37. Also, inexpensive second wires 23 are used as conductors for connecting the circuit board 30 to connectors not shown on the ECU side. Accordingly, an increase in the manufacturing costs of the wiring module 20 related to addition of the fuse function can be suppressed.

The wiring module 20 of the present embodiment includes the circuit board 30 constituted to include two conduction paths 34. The number of circuit boards 30 in the wiring module 20 can be reduced, compared to when only one conduction path 34 is formed on one circuit board 30, thus enabling the efficiency of the task of disposing the circuit boards 30 on the protector 50 to be improved.

As shown in FIG. 3, in the circuit board 30, two first lands 36 are arranged one on each of both left and right sides of the circuit board 30, and two second lands 37 are arranged at intermediate positions therebetween in the left-right direction. According to such a configuration, it is easy to dispose the circuit board 30 at an intermediate position in the left-right direction between two adjacent busbars 21. Also, it is easy to miniaturize the circuit board 30 to match the interval between the busbars 21 in the left-right direction.

### Method for Manufacturing Wiring Module

The configuration of the wiring module 20 is as described above, and, hereinafter, one example of a method for manufacturing the wiring module 20 will be described.

First, the crimping parts 62 of the terminals 60 are crimped onto the first wires 22. The end portions of these first wires 22 on the opposite side to the terminals 60 are fastened and fixed by the fastening parts 21A of the busbars 21, and the core wires 22A of the first wires 22 are welded to the busbars 21.

The circuit board 30 is manufactured using a printed wiring technology. The chip fuses 39 are soldered to the circuit board 30. The sealing parts 41 that seal the chip fuses 39 are formed. A liquid insulating resin before curing is dripped onto the connecting portions between the chip fuses 39 and the conduction paths 34 on the circuit board 30 using a dispenser or the like and applied in a dome shape. The applied insulating resin is cured by a known technique. Any technique can be appropriately selected as the technique for curing the insulating resin, such as cooling, mixing with a curing agent, or light irradiation.

The press-fit parts 64 of the terminals 60 are press-fit into the press-fit holes 32 in the circuit board 30 while pressing down on the pressing parts 66 of the terminals 60. The terminals 60 are fixed with respect to the circuit board 30, as a result of the press-fit parts 64 being arranged inside the press-fit holes 32. The terminals 60 are positioned with respect to the circuit board 30, by bringing the positioning raised parts 68 into contact with the end face of the circuit board 30. The connecting parts 63 of the terminals 60 are connected to the first lands 36 of the circuit board 30 by soldering.

The integrated busbars 21, circuit board 30, and first wires 22 are assembled to the protector 50. The busbars 21 are housed in the busbar housing part 51 of the protector 50. The busbars 21 are held within the busbar housing part 51 by the locking parts 51B. The circuit board 30 is disposed in the board holding part 52 of the protector 50. The protruding parts 52A are inserted into the insertion holes 31.

The second wires 23 are routed in the wire routing part 53, and the end portions of the second wires 23 where the core wires 23A are exposed are inserted within the wire insertion parts 53A. The core wires 23A of the second wires 23 are connected to the second lands 37 by soldering. Manufacturing of the wiring module 20 is thereby completed.

Note that the above is an example of the method for manufacturing the wiring module 20, and the order of the steps may be changed. For example, the second wires 23 may be soldered in the step of soldering the chip fuses 39 and the like to the circuit board 30. Also, welding of the busbars 21 to the first wires 22 may be performed after the busbars 21 are welded to the electrode terminals 12A and 12B.

### Operation and Effect of First Embodiment

The first embodiment achieves the following operation and effect.

The wiring module 20 according to the first embodiment is a wiring module 20 to be attached to a plurality of power storage devices 11, including a busbar 21 to be connected to electrode terminals 12A and 12B of the plurality of power storage devices 11, a circuit board 30, a first wire 22 electrically connecting the busbar 21 to the circuit board 30, and an second wire 23, with the circuit board 30 having formed thereon a conduction path 34 having a first land 36 electrically connected to the first wire 22, a second land 37 connected to the second wire 23, and a fuse part 38 provided between the first land 36 and the second land 37.

According to such a configuration, the wiring module 20 is provided with the first wire 22 and the second wire 23 in addition to the circuit board 30, thus enabling the amount of use of the circuit board 30 to be reduced, compared to when the first wire 22 and the second wire 23 are not provided. Therefore, the manufacturing costs of the wiring module 20 can be reduced.

In the first embodiment, the first wire 22 has a shape that curves between the end portion thereof on the busbar 21 side and the end portion thereof of the circuit board 30 side.

According to such a configuration, the first wire 22 electrically connecting the circuit board 30 and the busbar 21 is curved, thus allowing for displacement of the busbar 21 relative to the circuit board 30. Therefore, even if the power storage devices 11 expand or contract following a temperature change, or the busbars 21 deform due to an external force being applied to the wiring module 20, the circuit board 30 is unlikely to be damaged, and the electrical connection between the busbar 21 and the circuit board 30 can be maintained.

The wiring module 20 of the first embodiment further includes a terminal 60, and the terminal 60 includes a crimping part 62 crimped onto the end portion of the first wire 22 on the circuit board 30 side, and a connecting part 63 connected to the first land 36.

According to such a configuration, electrically connecting the first wire 22 and the first land 36 may be easier using the terminal 60.

In the first embodiment, the terminal 60 includes a press-fit part 64 that is different from the connecting part 63, and the circuit board 30 has a press-fit hole 32 into which the press-fit part 64 is press-fit.

According to such a configuration, the terminal 60 can be fixed with respect to the circuit board 30, by the press-fit part 64 being press-fit into the press-fit hole 32.

In the first embodiment, a plurality of (two) conduction paths 34 are formed on at least one of the circuit boards 30.

According to such a configuration, the number of circuit boards 30 used in the wiring module 20 can be reduced, thus enabling the ease of assembly of the wiring module 20 to be improved.

In the first embodiment, the circuit board 30 is a rigid board.

According to such a configuration, it is easy to improve the strength of the circuit board 30. Also, the manufacturing costs of the wiring module 20 can be suppressed, compared to the case where a flexible board is used as the circuit board 30.

In the first embodiment, the fuse part 38 is constituted by a chip fuse 39 that is connected to the conduction path 34 by solder S1.

According to such a configuration, the conduction path 34 can be protected from overcurrent, by the chip fuse 39 melting when overcurrent flows through the conduction path 34.

The wiring module 20 according to the first embodiment is a vehicle wiring module 20 to be electrically attached to the plurality of power storage devices 11 installed in a vehicle 1.

### Second Embodiment

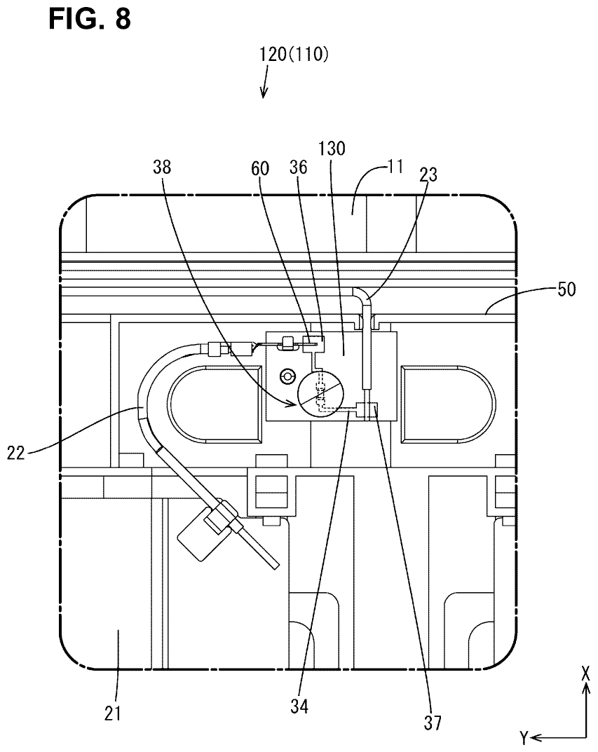

A second embodiment of the present disclosure will now be described with reference to FIG. 8. The configuration of the second embodiment is identical to the configuration of the first embodiment, except for inclusion of a circuit board 130. Hereinafter, members that are identical to the first embodiment will be given reference numerals used in the first embodiment, and description of configuration and operation and effect that are identical to the first embodiment will be omitted.

A wiring module 120 (power storage module 110) according to the second embodiment includes the circuit board 130. Only one conduction path 34 is formed on the circuit board 130. When such a circuit board 130 is used, it may be possible to eliminate unnecessary conduction paths 34 and miniaturize the circuit board 130, in cases such as where the circuit board 130 is disposed at an end portion of the wiring module 120 in the left-right direction, for example. Otherwise, the operation and effect are similar to the first embodiment, and thus description thereof will be omitted.

### Third Embodiment

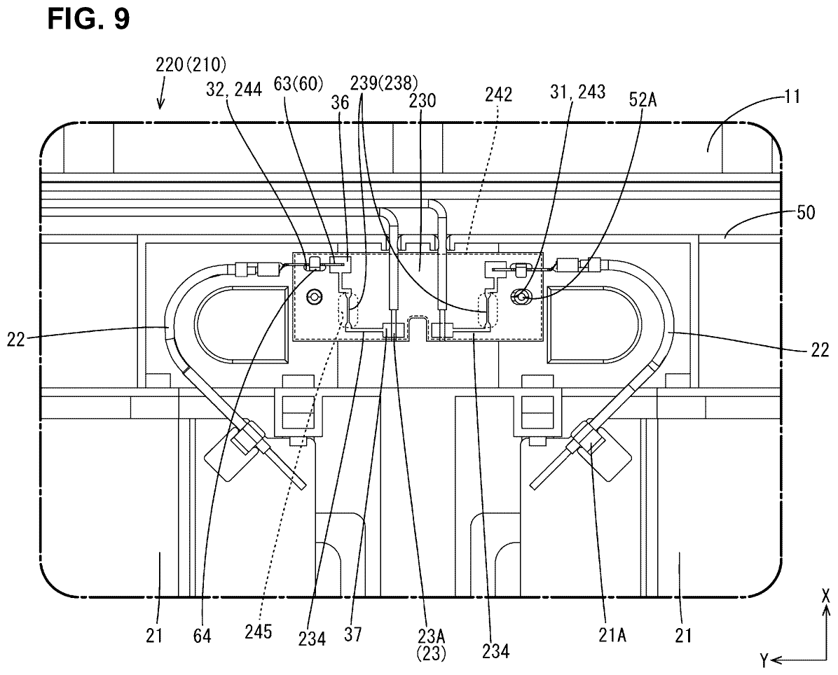

A third embodiment of the present disclosure will now be described with reference to FIG. 9. The configuration of the third embodiment is identical to the first embodiment, except for inclusion of a circuit board 230. Hereinafter, members that are identical to the first embodiment will be given reference numerals used in the first embodiment, and description of configuration and operation and effect that are identical to the first embodiment will be omitted.

A wiring module 220 (power storage module 210) according to the third embodiment includes the circuit board 230. The circuit board 230 is a flexible board having flexibility. The flexible board of the present embodiment is a flexible printed circuit board. The circuit board 230 includes a base film (not shown), a conduction path 234 routed on the surface of the base film, and a coverlay film (not shown) covering the conduction path 234. The base film and the coverlay film are made of a synthetic resin such as polyimide having insulating properties and flexibility. The coverlay film has openings that expose the portions where the conduction path 234 is soldered to other members.

A reinforcing plate 242 for reinforcing the flexible circuit board 230 is attached to a lower surface of the circuit board 230. In the present embodiment, the reinforcing plate 242 is an insulating member. The reinforcing plate 242 is formed by, for example, an epoxy resin being impregnated into a fiberglass cloth and cured. The reinforcing plate 242 is adhered to a region including at least the first lands 36, the second lands 37, and the hole edge portions of the press-fit holes 32. In the present embodiment, the reinforcing plate 242 is adhered to substantially the entirety of the circuit board 230. The reinforcing plate 242 has insertion holes 243 and press-fit holes 244 of respectively the same shape at positions corresponding to the insertion holes 31 and the press-fit holes 32 of the circuit board 230. Also, through holes 245 are formed in the reinforcing plate 242 at positions corresponding to fuse parts 238 of the circuit board 230.

The circuit board 230 includes the fuse parts 238. The fuse parts 238 are each constituted by a pattern fuse 239 provided by forming the conduction path 234 to be thin. The circuit board 230 is a flexible board having a thin film thickness, and heat is unlikely to escape in a film thickness direction of the circuit board 230, compared to the case of using a rigid board having a thick film thickness. Also, the through holes 245 are arranged in the reinforcing plate 242 at positions corresponding to the fuse parts 238, and thus heat is inhibited from escaping from the fuse parts 238 to the reinforcing plate 242. The pattern fuses 239 are formed to be thin, and thus heat up and melt when overcurrent occurs, enabling the flow of the overcurrent through the conduction path 234 to be restricted.

In the present embodiment, the pattern fuses 239 (fuse parts 238) can be constituted when forming the conduction path 234 in a normal manufacturing process of the circuit board 230. Accordingly, the step of constituting the fuse parts 38 in the first embodiment, that is, the step of connecting the chip fuses 39 to the end portions of the conduction paths 34 can be omitted.

In the present embodiment, the reinforcing plate 242 is adhered to the flexible board, and the press-fit holes 244 are provided at positions corresponding to the press-fit holes 32. The press-fit parts 64 of the terminals 60 are thereby easily press-fit and held with respect to the circuit board 230.

### Operation and Effect of Third Embodiment

The third embodiment achieves the following operation and effect.

In the third embodiment, the circuit board 230 is a flexible board.

According to such a configuration, the circuit board 230 can be provided with flexibility.

In the third embodiment, the fuse parts 238 are constituted by the pattern fuses 239.

According to such a configuration, the fuse parts 238 can be constituted in a manufacturing process of the flexible board.

In the third embodiment, the reinforcing plate 242 is adhered to the flexible board.

According to such a configuration, the strength of the flexible board can be improved.

### Other Embodiments

(1) In the first and third embodiments, one circuit board 30 and 230 is provided with two conduction paths 34, and, in the second embodiment, one circuit board 130 is provided with one conduction path 34, but the present disclosure is not limited thereto, and one circuit board may be provided with three or more conduction paths.

(2) In the first and second embodiments, the connecting portion between the chip fuse 39 and the conduction path 34 is sealed with the sealing part 41, but the present disclosure is not limited thereto, and the chip fuse need not be sealed with a sealing part.

(3) In the above embodiments, the wiring modules 20, 120, and 220 are provided with the protector 50, but the present disclosure is not limited thereto, and the wiring module need not be provided with a protector.

(4) In the above embodiments, the wiring modules 20, 120, and 220 are provided with terminals 60, but the present disclosure is not limited thereto, and the wiring module need not be provided with terminals, and the first wires may be directly connected to the circuit board.

(5) In the third embodiment, the fuse part 238 is constituted by the pattern fuse 239, but the present disclosure is not limited thereto, and the fuse part may be constituted by a chip fuse.

### LIST OF REFERENCE NUMERALS

1 Vehicle
2 Power storage pack
3 PCU
4 Wire harness
10, 110, 210 Power storage module
11 Power storage device
12A, 12B Electrode terminal
20, 120, 220 Wiring module
21 Busbar
21A Fastening part
22 First wire
22A Core wire
22B Insulation coating
23 Second wire
23A Core wire
23B Insulation coating
30, 130, 230 Circuit board
31 Insertion hole
31A First insertion hole
31B Second insertion hole
32 Press-fit hole
33 Insulating board
34, 234 Conduction path
34A Conduction path on first land side
34B Conduction path on second land side
35 Insulation layer
36 First land
37 Second land
38, 238 Fuse part
39 Chip fuse
40 Electrode
41 Sealing part
50 Protector
51 Busbar housing part
51A Connection hole
51B Locking part
51C Recessed part
52 Board holding part
52A Protruding part
53 Wire routing part
53A Wire insertion part
60 Terminal
61 Terminal body
62 Crimping part
62A Wire barrel
62B Insulation barrel
63 Connecting part
64 Press-fit part
64A Base part
64B Opposing plate part
64C Bent part
65 Extending part
5 66 Pressing part
67 Press-receiving part
68 Positioning raised part
239 Pattern fuse
242 Reinforcing plate
243 Insertion hole
244 Press-fit hole
245 Through hole
S1 Solder

1. A wiring module to be attached to a plurality of power storage devices, comprising:
a busbar to be connected to electrode terminals of the plurality of power storage devices;
a circuit board;
a first wire electrically connecting the busbar to the circuit board; and
a second wire,
wherein the circuit board has formed thereon a conduction path having a first land electrically connected to the first wire, a second land electrically connected to the second wire, and a fuse part provided between the first land and the second land.

2. The wiring module according to claim 1, wherein the first wire has a shape curving between an end portion thereof on the busbar side and an end portion thereof on the circuit board side.

3. The wiring module according to claim 1, further comprising:
a terminal,
wherein the terminal includes:
a crimping part crimped onto an end portion of the first wire on the circuit board side; and
a connecting part connected to the first land.

4. The wiring module according to claim 3,
wherein the terminal includes a press-fit part different from the connecting part, and
the circuit board has a press-fit hole into which the press-fit part is press-fit.

5. The wiring module according to claim 1, wherein the circuit board has a plurality of the conduction paths formed thereon.

6. The wiring module according to claim 1, wherein the circuit board is a rigid board.

7. The wiring module according to claim 1, wherein the fuse part is constituted by a chip fuse connected to the conduction path by solder.

8. The wiring module according to claim 1, wherein the circuit board is a flexible board.

9. The wiring module according to claim 8, wherein the fuse part is constituted by a pattern fuse.

10. The wiring module according to claim 8, wherein the flexible board has a reinforcing plate adhered thereto.

11. The wiring module according to claim 1 is a vehicle wiring module to be electrically attached to the plurality of power storage devices installed in a vehicle.
